(19) United States
(12) Patent Application Publication
(10) Pub. No.: US 2017/0353426 A1
(43) Pub. Date: Dec. 7, 2017

(54) CONNECTION GENERATION AND RECOGNITION SYSTEMS AND METHODS

(71) Applicant: Intertrust Technologies Corporation, Sunnyvale, CA (US)

(72) Inventor: Yutaka Nagao, Cupertino, CA (US)

(73) Assignee: Intertrust Technologies Corporation, Sunnyvale, CA (US)

(21) Appl. No.: 15/608,541

(22) Filed: May 30, 2017

Related U.S. Application Data
(60) Provisional application No. 62/345,255, filed on Jun. 3, 2016.

(51) Int. Cl. H04L 29/12; H04W 4/02; G06Q 50/00

(52) U.S. Cl. CPC H04L 61/1594; G06Q 50/01; H04W 4/023

(57) ABSTRACT

This disclosure relates to systems and methods that facilitate more efficient and/or improved connection generation in connection with social media and/or other contact, connection, and/or data management services. In some embodiments, devices associated with users may exchange certain device identification information when the devices are in relative close proximity, as may be the case when two users associated with the devices are interacting in person. The devices may communicate the exchanged device identification information to one or more social media and/or other contact or connection management services, which may generate one or more contacts and/or connections in profiles and/or accounts associated with the respective users.

### RELATED APPLICATIONS

This application claims the benefit of priority under 35 U.S.C. §119(e) to U.S. Provisional Application No. 62/345,255, filed Jun. 3, 2016, and entitled “CONNECTION GENERATION AND RECOGNITION SYSTEMS AND METHODS,” which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY

The present disclosure relates generally to connection and contact management services. More specifically, but not exclusively, the present disclosure relates to systems and methods for facilitating generation and recognition of connections using a connection or other contact management service.

Social media and/or other contact or connection management services are becoming increasingly important in how we interact both in person and online, as well as how we manage our personal and/or business relationships. When two individuals meet and form a personal and/or business connection, they may often later chose to connect online via one or more social media and/or contact or connection management services. In certain environments, however, they may not later recall certain information relating to newly formed connections, and thus may have difficulty later connecting online. For example, following a large business conference, an individual may have difficulty recalling the names and/or roles of certain personal connections made at the conference, and thus may have difficulty later connecting online with such connections via business-related social media services. Similarly, an individual may have difficulty recalling relevant information regarding individuals they have connected with online when they later meet such individuals in person (e.g., names, roles, etc.).

In addition, users often generate content in various social situations. For example, a user may take a photograph of various individuals attending a social gathering, record video relating to a public event, and/or the like. While generated content may be tagged and/or otherwise associated with a geographical location, it may not necessarily be well-associated with other individuals. For example, a photograph of an individual may be associated with a likely contact through facial recognition processes, but such methods of associating content with individuals may prove challenging when the accuracy of facial recognition algorithms are challenged by multiple contacts with similar facial features. Accordingly, it may be difficult for a user to accurately search through and/or otherwise identify various generated content based on associated contacts or connections.

Embodiments of the disclosed systems and methods may, among other things, facilitate more efficient and/or improved connection generation in connection with social media and/or other contact, connection, and/or data management services. In some embodiments, devices associated with users (e.g., a mobile device such as a smartphone or the like) may exchange certain device identification information using a wireless communication channel when the devices are in relative close proximity, as may be the case when two associated users are interacting in person. The devices may communicate the exchanged device identification information to one or more social media and/or other contact or connection management services, which may generate one or more contacts and/or connections in profiles and/or accounts associated with the respective users.

Further embodiments of the disclosed systems and methods may allow for notification of proximately-located contacts and/or connections. For example, when two devices are brought within relative proximity of each other, the devices may provide a notification to their respective users of nearby contacts based on exchanging associated device identification information. In some embodiments, contact information (e.g., name, photo, profession, role, etc.) relating to nearby contacts may further be provided in connection with such a notification. In this manner, a user's ability to quickly recall certain contact information relating to individuals they have connected with previously online when they later meet such individuals in person may be improved.

Additional embodiments of the disclosed systems and methods may facilitate association of generated content with individuals and/or contacts. In some embodiments, devices associated with users may exchange certain device identification information using a wireless communication channel when the devices are in relative close proximity, as may be the case when two associated users are interacting in person. Content generated when the devices are within a certain range and/or distance may be associated with the device identification information. For example, content generated by the devices when the devices are within a certain range may be tagged with the device identification information and/or other information associated therewith. In some embodiments, if the device identification information is associated with known contact information, the generated content may be tagged and/or otherwise associated with the contact information.

### BRIEF DESCRIPTION OF THE DRAWINGS

The inventive body of work will be readily understood by referring to the following detailed description in conjunction with the accompanying drawings, in which:

FIG. 1 illustrates connection generation consistent with embodiments of the present disclosure.

FIG. 2 illustrates an exemplary method of generating connections consistent with embodiments of the present disclosure.

FIG. 3 illustrates connection recognition consistent with embodiments of the present disclosure.

FIG. 4 illustrates an exemplary method for recognizing connections consistent with embodiments of the present disclosure.

FIG. 5 illustrates recognition of proximately-located devices consistent with embodiments of the present disclosure.

FIG. 6 illustrates association of generated content with device identification information consistent with embodiments of the present disclosure.

FIG. 7 illustrates an exemplary method for associating generated content with device identification information consistent with embodiments of the present disclosure.

FIG. 8 illustrates another example of connection recognition consistent with embodiments of the present disclosure.

FIG. 9 illustrates an exemplary system that may be used to implement embodiments of the systems and methods of the present disclosure.

### DETAILED DESCRIPTION

A detailed description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may be designated by like numerals or descriptions. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure but is merely representative of possible embodiments of the disclosure. In addition, the steps of any method disclosed herein do not necessarily need to be executed in any specific order, or even sequentially, nor need the steps be executed only once, unless otherwise specified.

Embodiments of the disclosed systems and methods may, among other things, facilitate more efficient and/or improved connection generation using social media and/or other contact, connection, and/or data management services. Consistent with embodiments disclosed herein, devices associated with users may exchange device identification information using a wireless communication channel when the devices are in relative close proximity. Exchanged device identification information may be used in connection with one or more social media and/or other contact or connection management services to identify possible connections and/or generate actual connections between device users. In some embodiments, the disclosed systems and methods may allow for notification of proximately-located contacts and/or connections. In further embodiments, the disclosed systems and methods may facilitate association of content generated by user devices with one or more contacts and/or connections.

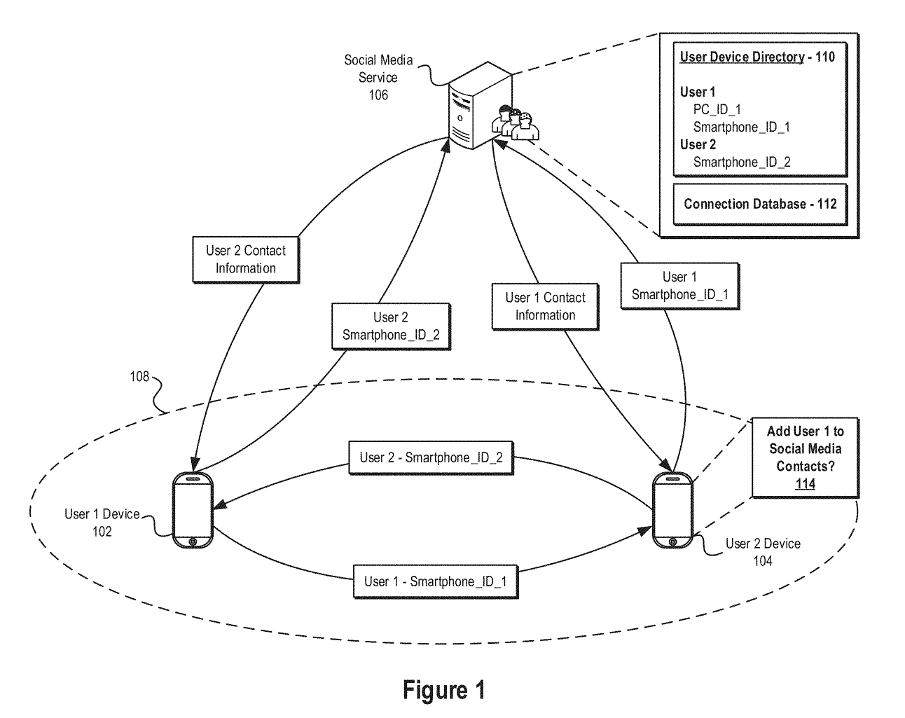

FIG. 1 illustrates connection generation consistent with embodiments of the present disclosure. As illustrated, one or more user devices 102, 104 may interact with a social media service 106 in connection with connection generation and/or management processes consistent with the disclosed embodiments. Although embodiments disclosed herein are discussed in connection with a social media service 106, it will be appreciated that embodiments may be used in connection with a variety of other suitable contact and/or connection management services.

The user devices 102, 104, social media service 106, and/or one or more other service providers or systems (not shown) may comprise any suitable computing system or combination of systems configured to implement embodiments of the systems and methods disclosed herein. In certain embodiments, the user devices 102, 104, social media service 106, and/or other service providers or systems may comprise at least one processor system configured to execute instructions stored on an associated non-transitory computer-readable storage medium. As discussed in more detail below, the user devices 102, 104, social media service 106, and/or other service providers or systems may further comprise a secure processing unit (“SPU”) configured to perform sensitive operations such as trusted credential and/or key management, secure policy management, and/or other aspects of the systems and methods disclosed herein. The user devices 102, 104, social media service 106, and/or other service providers or systems may further comprise software and/or hardware configured to enable electronic communication of information between the devices and/or services via one or more associated network connections.

The user devices 102, 104 and/or social media service 106 may comprise a computing device executing one or more applications configured to implement embodiments of the systems and methods disclosed herein. In certain embodiments, the user devices 102, 104 may comprise at least one of a smartphone, a laptop computer system, a desktop computer system, a tablet computer, and/or any other computing system and/or mobile device that may be used in connection with the disclosed systems and methods. In certain embodiments, the user devices 102, 104 may comprise software and/or hardware configured to, among other things, exchange device identification information when the devices 102, 104 are in relative close proximity to each other (e.g., when two associated users are interacting in person), communicate the exchanged device identification information to the social media service 106, and/or receive associated connection and/or contact information relating to the device identification information (e.g., name, photo, profession, role, etc.). In some embodiments, such functionality and/or aspects thereof may be implemented using one or more applications executing on the user devices 102, 104 associated with the social media service 106 (e.g., a social media application and/or the like).

The user devices 102, 104 may communicate with the social media service 106 and/or each other via one or more networks comprising any suitable number of networks and/or network connections. The network connections may comprise a variety of network communication devices and/or channels and may use any suitable communication protocols and/or standards facilitating communication between the connected devices and systems. For example, in some embodiments the network may comprise the Internet, a local area network, a virtual private network, and/or any other communication network utilizing one or more electronic communication technologies and/or standards (e.g., Ethernet and/or the like). In some embodiments, the network connections may comprise a wireless carrier system such as a personal communications system (“PCS”), and/or any other suitable communication system incorporating any suitable communication standards and/or protocols. In further embodiments, the network connections may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network connections may incorporate one or more satellite communication links. In yet further embodiments, the network connections may use IEEE's 802.11 standards, Bluetooth®, ultra-wide band (“UWB”), Zigbee®, and or any other suitable communication protocol(s).

The user devices 102, 104 may be configured to communicate with each other via any suitable type of wired and/or wireless communication protocol(s) that may enable communication between the devices 102, 104 when the devices 102, 104 are in close relative proximity to each other. For example, the user 102, 104 devices may communicate using Near Field Communication (“NFC”), radio-frequency identification (“RFID”) communication, TransferJet, Zigbee®, Bluetooth® including Bluetooth® low energy, IEEE's 802.11 standards, and/or other suitable wired and/or wireless communication protocols including any of the communication protocols disclosed herein.

User devices 102, 104 may engage in a polling process to determine when another user device 102, 104 is within a certain range 108. When another user device 102, 104 is discovered, device identification information associated with the devices 102, 104 may be exchanged between the devices 102, 104. In some embodiments, device identification information may be exchanged automatically. For example, a user of a device 102, 104 may indicate their willingness to automatically communicate and/or exchange associated device identification information with other users and/or devices 102, 104 when devices 102, 104 are discovered within a certain range 108. In other embodiments, device identification information may be exchanged in response to a request by one or more of the users associated with the devices 102, 104 (e.g., in response to a pop-up and/or other notification or prompting provided on displays of the devices 102, 104). While certain embodiments disclosed herein are discussed in connection with a polling device discovery process, it will be appreciated that other suitable device identification and/or detection techniques may also be used.

For example, as illustrated in FIG. 1, a first user device 102 and a second user device 104 may be brought within a certain relative distance and/or range 108 of each other. In some embodiments, the range 108 may be associated with a communication range of a wireless communication channel that enables communication between the devices 102, 104.

The first device 102 may engage in a polling process and identify the proximately-located second device 104. Similarly, the second device 104 may engage in a polling process and identify the proximately-located first device 102. After discovering a proximately-located device, the devices 102, 104 may exchange device identification information. For example, the first device 102 may exchange its device identification information—Smartphone_ID_1—with the second device 104, and the second device 104 may exchange its device identification information—Smartphone_ID_2—with the first device 102.

In some embodiments, prior to exchanging the device identification information, the devices 102, 104 may notify a user and allow the user to control whether their associated device identification information should be exchanged with the proximately-located device 102, 104. For example, a pop-up menu and/or other notification may be displayed on the first device 102 notifying a user of the first device 102 that the second device 104 is within range 108 and inquiring whether the user would like to send their device identification information to the second device 104. If the user indicates they would like to send their associated device identification information to the second device 104, the first device 102 may communicate its associated device identification information—Smartphone_ID_1—to the second device 104.

Device identification information exchanged between the user devices 102, 104 may comprise a variety of different types of information that uniquely identify a particular device and/or a device associated with a user. In some embodiments, the device identification may comprise a unique device identifier such as a media access control (“MAC”) address. In other embodiments, the device identification information may be derived based on unique personal information associated with a user device 102, 104 such as, for example, a hash value calculated based on unique information stored on the user device 102, 104 (e.g., a hash of a MAC value, a key associated with the device and/or the like). It will be appreciated that a variety of suitable types of device identification information may be used in connection with the disclosed embodiments.

In certain embodiments, users may register their associated devices 102, 104 with the social media service 106, which may maintain a directory 110 comprising entries associating registered device identification information with particular users and/or devices 102, 104.

For example, when signing up for an account with a social media service 106, a user may provide the social media service 106 with device identification information associated with one or more devices associated with the user. After exchanging device identification information, the user devices 102, 104 may communicate the device identification information to the social media service 106. The social media service 106 may determine whether the device identification information is associated with a device registered within its directory 110 and, if so, identify an associated user. For example, the user of the first device 102 may transmit the device identification information received from the second device 104—Smartphone_ID_2—to the social media service 106.

The social media service 106 may then compare the received device identification information with known device identification information included in its directory 110. If the received device identification information is associated with a registered device, information relating to a user associated with the registered device and/or the received device identification may be identified. For example, the social media service 106 may determine that the device identification information received from the first device 102—Smartphone_ID_2—is associated with the second device 104 using the directory 110 and identify information relating to a user associated with the second device 104.

Identified information may be communicated from the social media service 106 to relevant user devices 102, 104. In certain embodiments, the identified information may comprise contact information associated with an identified user. The identified contact information may be returned to the relevant user devices 102, 106, which may use the received information to populate contact lists and/or other connection management services and/or applications managed locally on the user devices 102, 104. For example, as illustrated, after identifying that the device identification information received from the second device 104—Smartphone_ID_1—is associated with the user of the first device 102, the social media service 106 may communicate contact information associated with the user of the first device 102 to the second device 104.

Upon receipt of contact information from the social media service 106, the devices 102, 104 may prompt users to determine whether they would like to add the user associated with the received contact information to contact lists managed by the devices 102, 106 and/or as connections in one or more social media services 106. For example, a user may be provided with a pop-up notification and/or other prompt 114 inquiring whether they would like to add the other user to their social media connections. In some embodiments, if a user accepts adding the user associated with the received contact information to a social media service 106, an appropriate indication may be generated by the device 104 and communicated to the social media service 106. In response, the social media service 106 may generate a connection between the users in a connection database 112 managed by the social media service 106.

It will be appreciated that a number of variations can be made to the architecture, relationships, and examples presented in connection with FIG. 1 within the scope of the inventive body of work. For example, certain functionalities of the social media service 106 may be performed by one or more of the devices 102, 104. Further certain functionalities of the devices 102, 104 may be performed by the social media service 106. Certain other device and/or system functionalities described above may be integrated into a single device and/or system and/or any suitable combination of devices and/or systems in any suitable configuration. Thus it will be appreciated that the architecture, relationships, and examples presented in connection with FIG. 1 are provided for purposes of illustration and explanation, and not limitation.

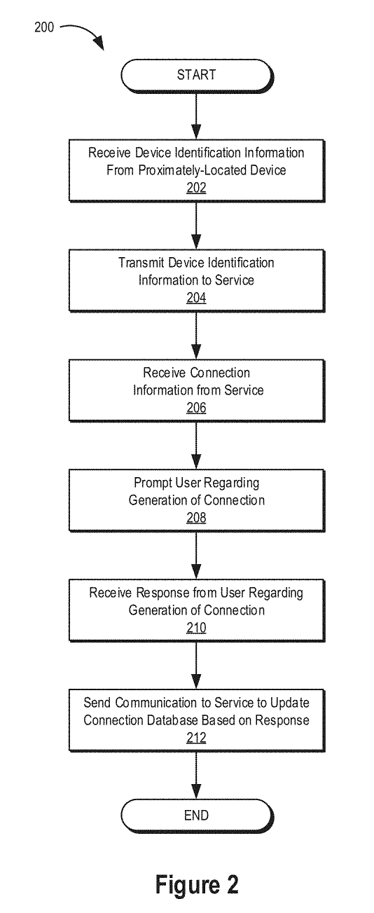

FIG. 2 illustrates an exemplary method 200 of generating connections consistent with embodiments of the present disclosure. The illustrated method 200 may be implemented in a variety of ways, including using software, firmware, hardware, and/or any combination thereof. In certain embodiments, the method 200 may be implemented by an electronic device associated with a user.

At 202, device identification information may be received from a proximately-located device. In certain embodiments, the device identification information may be received via a NFC, RFID, Bluetooth®, IEEE's 802.11, and/or other suitable wireless communication channel. In some embodiments, proximately-located devices may be identified as part of a polling process to determine when another device is within a certain range of a user's device. In further embodiments, when another device is identified, a user may be prompted regarding whether they would like to receive device identification information from the proximately-located device or, alternatively, whether they would like to transmit their device identification information to a proximately-located device.

The received device identification information may be transmitted to a social media and/or contact or connection management service at 204. The social media and/or contact or connection management service may determine whether the received device identification information is associated with one or more known devices and/or users. If the received device identification information is associated with one or more known devices and/or users, the social media and/or contact or connection management service may identify relevant contact or connection information associated with the known devices and/or users and return the identified information to the user device, which may be received by the user device at 206.

At 208, the user device may display an interactive prompt and/or other notification inquiring whether a user would like to add the user associated with the contact or connection information received at 206 to contact lists managed by the user device and/or as connections in one or more social media services. A user may provide a response to the interactive prompt and/or notification at 210, and an appropriate communication may be generated by the user device and sent to the social media and/or contact or connection management service at 212. For example, if a user accepts adding a user associated with the received contact or connection information to a social media service, an appropriate indication may be generated by the user device and communicated to the social media service. In response, the social media service may generate a connection between the users in a connection database managed by the social media service 106. In further embodiments, contact and/or social connection information managed locally on a user's device may be updated based on the user response received at 210.

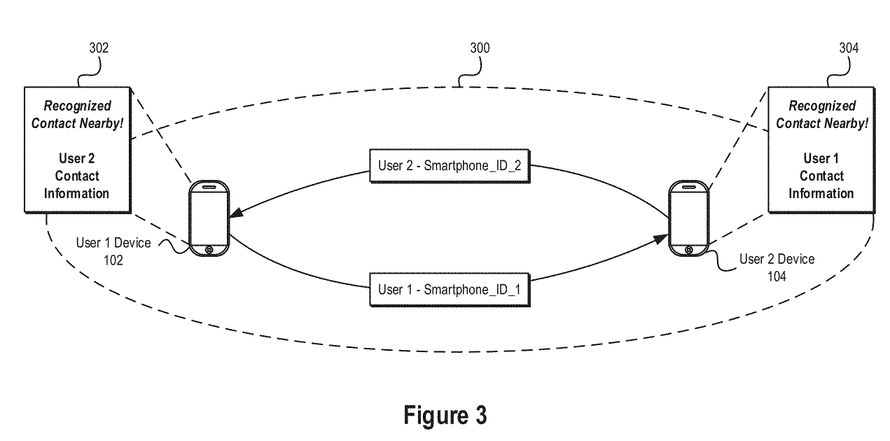

FIG. 3 illustrates connection recognition consistent with embodiments of the present disclosure. In some embodiments, the disclosed systems and methods may allow for users to be notified of proximately-located contacts and/or connections by their associated devices 102, 104. For example, as illustrated, when two devices 102, 104 are brought within relative proximity of each other (e.g., within a communication range 300 of a wireless communication channel that enables communication between the devices 102, 104), the devices 102, 104 may exchange associated device identification information consistent with the disclosed embodiments.

Based on the exchanged device identification information, the user devices 102, 104 may determine whether the users associated with the devices 102, 104 are recognized contacts or connections and/or have previously exchanged device identification information. In certain embodiments, this determination may be performed using information managed locally on the user devices (e.g., via locally-managed contact lists and/or connection directories). In further embodiments, this determination may be performed using, at least in part, information obtained by one or more social media and/or contact or connection management services in communication with the user devices 102, 104.

If the users associated with the devices 102, 104 are recognized contacts or connections and/or have previously exchanged device identification information, the user devices may provide a notification to their respective users of the nearby contact and/or connection. In some embodiments, a pop-up notification and/or other alert 302 may be provided on the displays of the user devices. For example, when the first device 102 receives device identification information—Smartphone_ID_2—from the second device 104 and determines that the received device identification information is associated with a recognized contact or connection, a notification 302 may be displayed on the first device 102 indicating that the recognized user of the second device 104 is nearby. Similarly, when the second device 104 receives device identification information—Smartphone_ID_1—from the first device 102 and determines that the received device identification information is associated with a recognized contact or connection, a notification may be displayed on the second device 104 indicating that the recognized user of the first device 102 is nearby. In some embodiments, contextual information, as discussed in more detail below, may also be used in connection with determining whether to provide a notification 302, 304 to users of nearby contacts and/or connections via their respective devices 102, 104.

In certain embodiments, contact information relating to identified nearby contacts or connection may further be provided in connection with such notifications 302, 304 (e.g., name, e-mail address, phone number, photo, occupation, role, etc.). In this manner, a user's ability to quickly recall certain contact information relating to individuals they have connected with previously when they later meet such individuals may be improved. As discussed in more detail below, certain content associated with contacts and/or connections may be further displayed in connection with notifications 302, 304 of nearby contacts or connections.

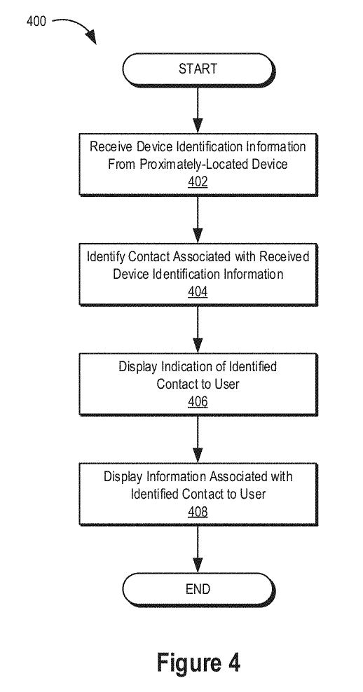

FIG. 4 illustrates an exemplary method for recognizing connections consistent with embodiments of the present disclosure. The illustrated method 400 may be implemented in a variety of ways, including using software, firmware, hardware, and/or any combination thereof. In certain embodiments, the method 400 may be implemented by an electronic device associated with a user.

At 402, device identification information may be received from a proximately-located device. In some embodiments, a proximately-located device may be identified and device identification information may be received as part of a polling process identifying when another device is within a certain range of a user's device.

Based on the received device identification information, the user device may determine whether a user associated with the received device identification information is a recognized contact or connection and/or whether the received device identification information has been previously received at 404. This determination may be performed using information managed locally on the user device and/or using information obtained from one or more social media and/or contact or connection management services.

At 406, a prompt or notification may be displayed on the device providing an indication to the user of the identified contact or connection or whether the device identification information has been previously received by the device. At 408, contact information relating to identified contacts or connection may further be displayed on the user device. For example, a name, photo, occupation, role, and/or other biographical information relating to an identified contact and/or connection may be displayed. In some embodiments, content associated with an identified contact and/or connection may be further displayed on the user device.

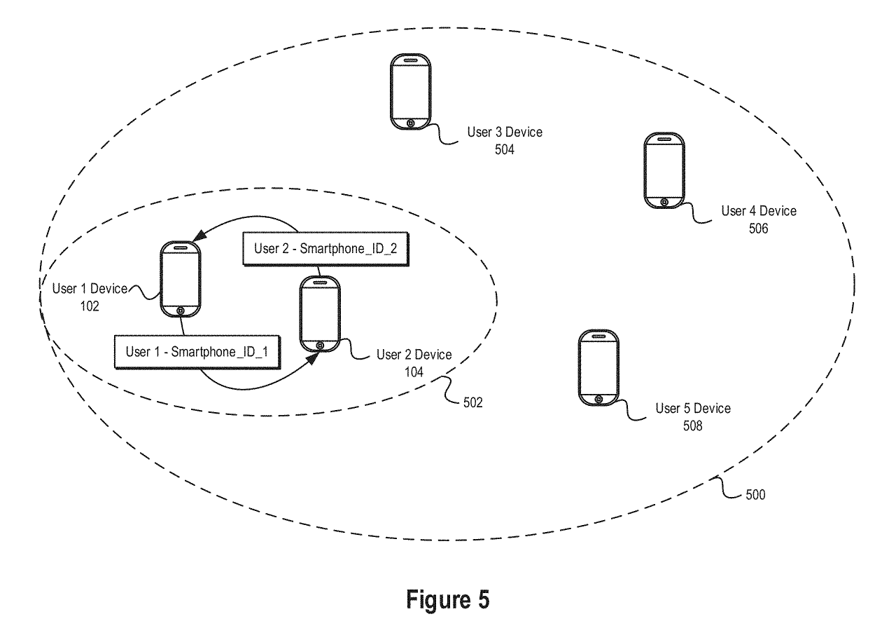

FIG. 5 illustrates recognition of proximately-located user devices 102, 104, 504-508 consistent with embodiments of the present disclosure. In certain embodiments, the user devices 102, 104, 504-508 may analyze certain contextual information to determine the likelihood that associated users are interacting in person prior to automatically exchanging device identification information and/or prompting a user to exchange such information. For example, the user devices 102, 104, 504-508 may determine that if a large number of user devices 102, 104, 504-508 are located within a relatively small area, which may be the case if the users are located in a crowded area such as a train, on an elevator, and/or driving in traffic, it may be less likely that the users are interacting in person. Accordingly, in such circumstances, the user devices 102, 104, 504-508 may not automatically exchange device identification information and/or prompt a user to exchange such information.

In some circumstances, as illustrated in FIG. 5, a number of user devices 102, 104, 504-508 may be located within a communication range 500 of various wireless communication channels that enable communication between the devices 102, 104, 504-508. Due to the relative distance between the various devices 102, 104, 504-508 and/or the relative movement of the devices 102, 104, 504-508, certain devices (e.g., devices 104, 104) may be more likely to be associated with users that are engaging in personal and/or business interactions. For example, as illustrated, devices 102 and 104 may be located relatively closer to each other than devices 504-508, and thus are more likely to be associated with users engaging in a social interaction. Accordingly, a smaller range 502 may be used to identify proximate devices for exchanging device identification information consistent with the disclosed embodiments to reflect likely user interaction.

Similarly, devices 102 and 104 may be relatively stationary compared to devices 504-508, and thus are more likely to be associated with users engaging in a social interaction than the transitory devices 504-508. In some circumstances, devices 102 and 104 may be transitory but traveling in a similar direction compared to devices 504-508, and therefore may be more likely to be associated with users engaging in a social interaction while moving than devices 504, 508. Accordingly, devices 102 and 104 may exchange device identification information whereas devices 504-508 may not. In this manner, the relevant movement of devices may be used to identify proximate devices for exchange of device identification consistent with embodiments disclosed herein.

In other embodiments, other contextual information, including location information associated with user devices 102, 104, 504-508 may be used to determine the likelihood that users are engaging in social interactions. For example, a user may be more likely to be engaged in a personal and/or business interaction with another user when the users are located in an office or a school than if the users are located in a retail checkout line and/or a washroom. In this manner, the exchange of device identification information between devices 102, 104, 504-508 may be dependent on a contextual location of the devices 102, 104, 504-508.

In yet further embodiments, a range (e.g., range 500, 502) used by devices to identify other proximate devices 102, 104, 504-508 likely associated with interacting users may vary based on location. For example, at a restaurant, a relatively smaller range 502 may be used to reduce the likelihood of identifying patrons at other nearby tables that are not necessarily interacting socially. In contrast, a larger range 500 may be used in an office conference room or the like, where users associated with various devices 102, 104, 504-508 are more likely to be socially interacting.

Contextual location information may further be used to distinguish between personal and/or business interactions and/or take certain actions based on the same. For example, interactions in an office are more likely to be business interactions than interactions in a local park. Based on such information, consistent with the disclosed embodiments, relevant contacts or connections may be generated in an appropriate and/or related social media service or contact and/or connection management service (e.g., a business-oriented social media service and/or the like).

In certain embodiments, contextual information used in connection with identifying proximate devices 102, 104, 504-508 likely associated with users that are interacting socially may be generated, at least in part, by a variety of sensor systems associated with the user devices 102, 104, 504-508 (e.g., location sensors or the like). It will be appreciated that a wide variety of contextual information may be used for determining a likelihood that users associated with devices 102, 104, 504-508 are interacting socially, and that any suitable type or types of contextual information may be used in connection with the disclosed embodiments.

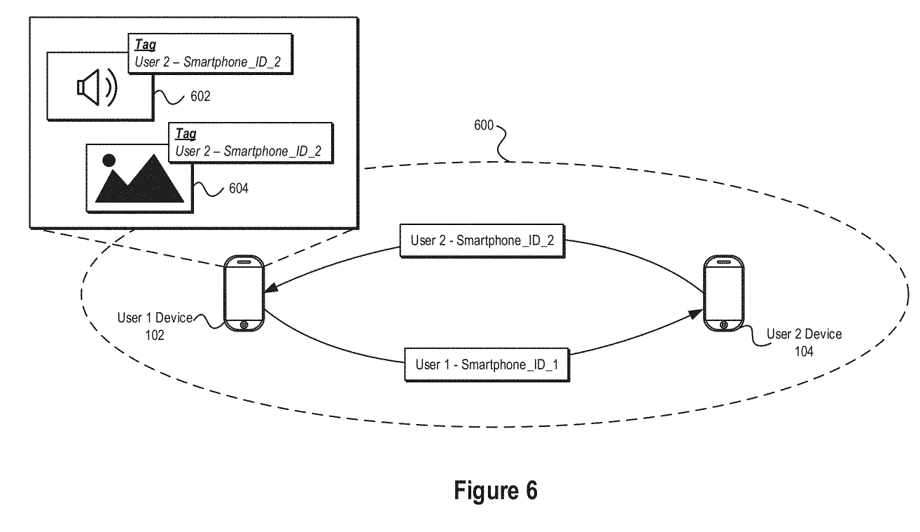

FIG. 6 illustrates association of generated content 602, 604 with device identification information consistent with embodiments of the present disclosure. As discussed above, consistent with the disclosed embodiments, devices 102, 104 may exchange device identification information using a wireless communication channel when the devices 102, 104 are within a certain range 600 and/or proximity of each other, as may be the case when two users associated with the devices 102, 104 are interacting in person.

User devices 102, 104 may further be capable of generating a variety of electronic content in connection with social and/or other events. For example, using an electronic device 102, 104, a user may take a photograph of various individuals attending a social gathering, record video of a public event, record audio of a performance or meeting, and/or the like. Consistent with embodiments disclosed herein, content 602, 604 generated by user devices 102, 104 may be associated with device identification information received by the devices 102, 2014. For example, as illustrated, when two devices 102, 104 are brought within relative proximity of each other (e.g., within a communication range 600 of a wireless communication channel that enables communication between the devices 102, 104), the devices 102, 104 may exchange associated device identification information.

Consistent with embodiments disclosed herein, various content 602, 604 generated by the user devices when the devices 102, 104 are within the communication range 600 and/or another threshold range of each other may be associated with exchanged device information. For example, as illustrated, a first device 102 may capture audio content 602 and photographic content 602, 604 when the first device 102 is located near the second device 102. Consistent with various disclosed embodiments, the first device 102 may tag and/or otherwise associated the generated content 604 with the device identification information received from the second device 104. For example, metadata associated with content 602, 604 generated by the first device 102 may include the device identification information received from the second device 104. In this manner, the content 602, 604 generated by the first service 102 may be searched, indexed, and/or organized based, at least in part, on the device identification information received from the second device 104.

In some embodiments, device identification information exchanged between devices 102, 104 may be associated with a recognized and/or otherwise known contact or connection. For example, as detailed above, a contact or connection associated with received device identification information may be identified by interacting with a communicatively-connected social media service and/or using contact or connection directory information managed locally on a user's device 102, 104. If the received device identification information is associated with a known contact or connection, a device 102, 104 may tag and/or otherwise associate generated content 602, 604 with the contact or connection associated with the received device identification information. For example, metadata associated with content 602, 604 generated by the first device 102 may include an identification of a contact and/or connection associated with the device identification information received from the second device 104. In this manner, the content 602, 604 generated by the first service 102 may be searched, indexed, and/or organized based, at least in part, on the identity of the contact or connection associated with device identification information received from the second device 104.

Among other things, associating content generated by user devices with exchanged device identification information and/or associated contacts or connections consistent with various disclosed embodiments may allow for a user to interact with generated content based on social relationships in a number of intuitive ways. For example, a user may capture a number of photographs standing near and/or close to an individual to whom they have not been formally introduced. The captured photographs may be initially tagged and/or otherwise associated with device identification information associated with a device of the individual. Subsequently, the user may be introduced to the individually socially, and may become formally connected via a social media service and/or be introduced into the user's contact list. Upon generating this a formal social media connection and/or contact, the previously captured photographs be further associated with information identifying the connection and/or contact. The user may therefore search, browse, and/or otherwise interact with, based on the identity of their social connections or contacts, content captured by their device that was generated prior to the users becoming formally socially connected.

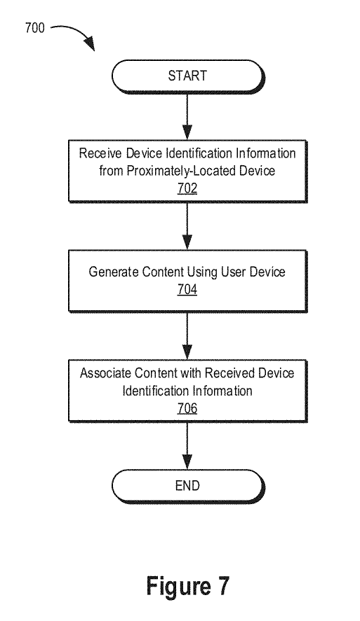

FIG. 7 illustrates an exemplary method 700 for associating generated content with device identification information consistent with embodiments of the present disclosure. The illustrated method 700 may be implemented in a variety of ways, including using software, firmware, hardware, and/or any combination thereof. In certain embodiments, the method 700 may be implemented by an electronic device associated with a user.

At 702, device identification information may be received from a proximately-located device. In some embodiments, a proximately-located device may be identified and device identification information may be received as part of a polling process identifying when another device is within a certain range of a user's device.

Content may be generated by the device at 704 when the device is located near the other device. For example, a user may take a photograph of various individuals attending a social gathering, record video of a public event, record audio of a performance or meeting, and/or the like. At 706, the content generated at 704 may be associated with the device identification information received at 702. For example, the received device identification may be included in metadata associated with the content. In further embodiments, if the received device identification information is associated with one or more known contacts or connections, the known contacts or connections may be associated with the generated content In this manner, the content may be searched, indexed, and/or organized based on whether it was generated in proximity to other devices and/or known users or connections using the associated device identification information.

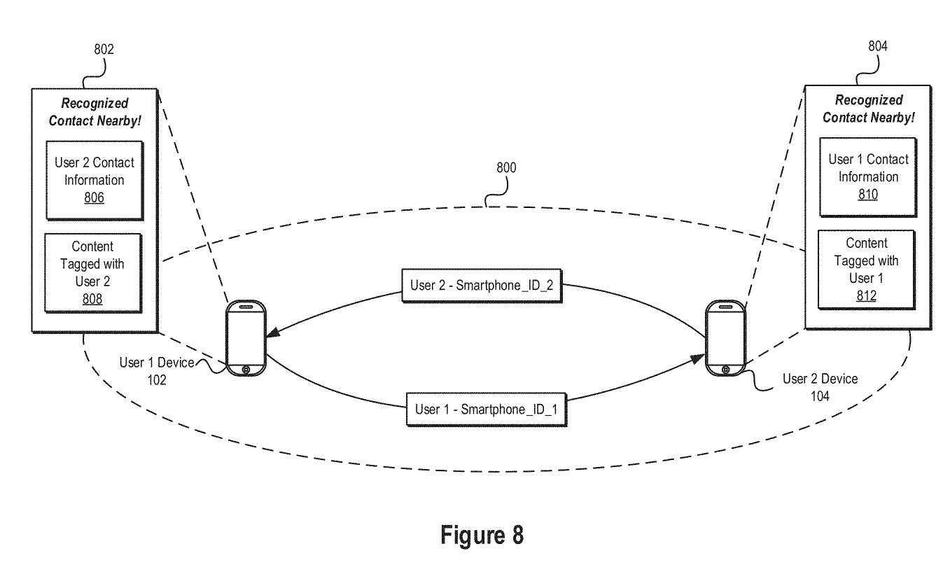

FIG. 8 illustrates another example of connection recognition consistent with embodiments of the present disclosure. In some embodiments, the disclosed systems and methods may allow for users to be notified of proximately-located contacts and/or connections by their associated devices 102, 104 and provide an indication of certain content associated with the identified contacts and/or connections. For example, as illustrated, when two devices 102, 104 are brought within relative proximity of each other (e.g., within a communication range 800 of a wireless communication channel that enables communication between the devices 102, 104), the devices 102, 104 may exchange associated device identification information consistent with the disclosed embodiments.

Based on the exchanged device identification information, the user devices 102, 104 may determine whether the users associated with the devices 102, 104 are recognized contacts or connections and/or have previously exchanged device identification information. In certain embodiments, this determination may be performed using information managed locally on the user devices (e.g., via locally-managed contact lists and/or connection directories). In further embodiments, this determination may be performed using, at least in part, information obtained by one or more social media and/or contact or connection management services (not shown) in communication with the user devices 102, 104.

If the users associated with the devices 102, 104 are recognized contacts or connections and/or have previously exchanged device identification information, the user devices 102, 104 may provide notifications 802, 804 to their respective users of the nearby contact and/or connection. In some embodiments, a pop-up notification and/or other alert 802 may be provided on the displays of the user devices. For example, when the first device 102 receives device identification information—Smartphone_ID_2—from the second device 104 and determines that the received device identification information is associated with a recognized contact or connection, a notification 802 may be displayed on the first device 102 indicating that the recognized user of the second device 104 is nearby. Similarly, when the second device 104 receives device identification information—Smartphone_ID_1—from the first device 102 and determines that the received device identification information is associated with a recognized contact or connection, a notification 804 may be displayed on the second device 104 indicating that the recognized user of the first device 102 is nearby.

In certain embodiments, contact information 806, 810 relating to identified nearby contacts or connection may further be provided in connection with such notifications 804, 806 (e.g., name, photo, occupation, role, etc.). In addition, content 808, 812 generated by devices 102, 104 that is associated with the exchanged device identification information may be displayed in connection with the notifications 802, 804.

For example, when the first device 102 receives device identification information—Smartphone_ID_2—from the second device 104 and determines that the received device identification information is associated with a recognized contact or connection, a notification 802 may be displayed on the first device 102 indicating that the recognized user of the second device 104 is nearby and providing the user's contact information 806 and any content 808 generated by device that has been tagged with the recognized user of the second device 104 and/or the device identification information received from the second device 104. Similarly, when the second device 104 receives device identification information—Smartphone_ID_1—from the first device 102 and determines that the received device identification information is associated with a recognized contact or connection, a notification 804 may be displayed on the second device 104 indicating that the recognized user of the first device 102 is nearby and providing the user's contact information 810 and any content 812 generated by device that has been tagged with the recognized user of the first device 102 and/or the device identification information received from the first device 102. By displaying relevant contact information 806, 810 and associated content 808, 812, a user's ability to quickly recall certain contact information relating to individuals they have connected with previously when they later meet such individuals may be improved.

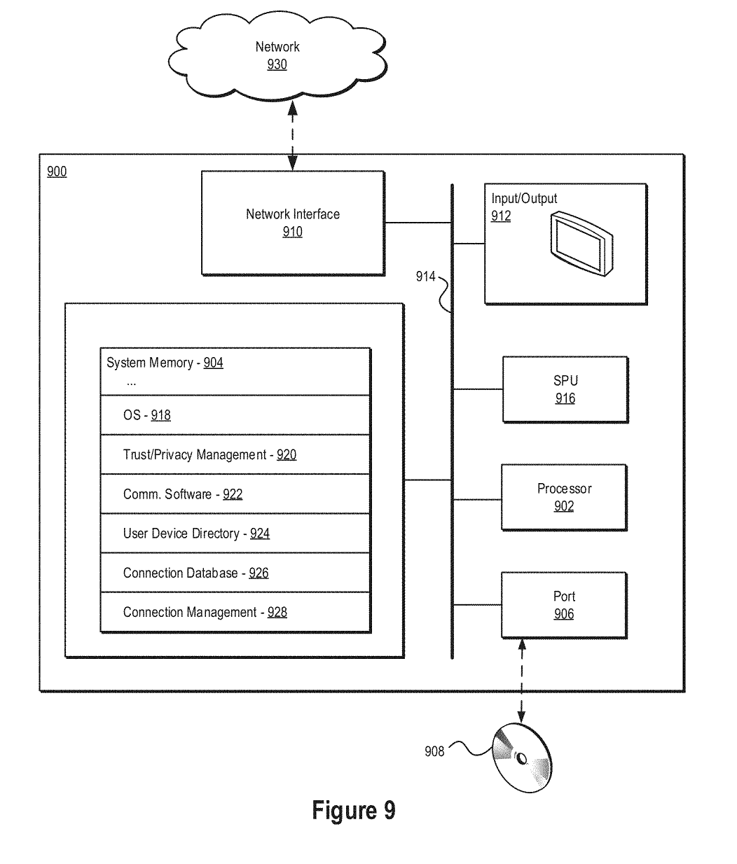

FIG. 9 illustrates an exemplary system 900 that may be used to implement embodiments of the systems and methods of the present disclosure. Certain elements associated with the illustrated exemplary system 900 may be included in a user device, a social media service and/or other contact and/or connection management service consistent with embodiments disclosed herein, and/or any other system configured to implement embodiments of the disclosed systems and methods.

As illustrated in FIG. 9, the system 900 may include: a processing unit 902; system memory 904, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit; a port 906 for interfacing with removable memory 908 that may include one or more diskettes, optical storage mediums, and/or other non-transitory computer-readable storage mediums (e.g., flash memory, thumb drives, USB dongles, compact discs, DVDs, etc.); a network interface 910 for communicating with other systems via a network 930 using one or more network connections using one or more communication technologies; a user interface 912 that may include a display and/or one or more input/output devices such as, for example, a touchscreen, a keyboard, a mouse, a track pad, and the like; and one or more busses 914 for communicatively coupling the elements of the system 900.

In some embodiments, the system 900 may, alternatively or in addition, include an SPU 916 that is protected from tampering by a user of the system or other entities by utilizing secure physical and/or virtual security techniques. An SPU 916 can help enhance the security of sensitive operations such as personal information management, trusted credential and/or key management, privacy and policy management, versioning control and/or management, and other aspects of the systems and methods disclosed herein. In certain embodiments, the SPU 916 may operate in a logically secure processing domain and be configured to protect and operate on secret information, as described herein. In some embodiments, the SPU 916 may include internal memory storing executable instructions or programs configured to enable the SPU 916 to perform secure operations, as described herein.

The operation of the system 900 may be generally controlled by a processing unit 902 and/or an SPU 916 operating by executing software instructions and programs stored in the system memory 904 (and/or other computer-readable media, such as removable memory 908). The system memory 904 may store a variety of executable programs or modules for controlling the operation of the system 900. For example, the system memory 904 may include an operating system (“OS”) 918 that may manage and coordinate, at least in part, system hardware resources and provide for common services for execution of various applications and a trust and privacy management system 920 for implementing trust and privacy management functionality including protection and/or management of personal data through management and/or enforcement of associated policies. The system memory 904 may further include, without limitation, communication software 922 configured to enable in part communication with and by the system; one or more applications; a user device directory 924 storing information associating registered device identification information with users, a connection database 926 managing connections between users, and a connection management engine 928 configured to manage information in the user device directory and/or the connection database, generate connections, provide other user information to one or more user devices, and/or any other information and/or applications configured to implement embodiments of the systems and methods disclosed herein.

The systems and methods disclosed herein are not inherently related to any particular computer, device, service, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, an optical storage medium, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims.

What is claimed is:

1. A method for managing contacts performed by a first device comprising a processor and a non-transitory computer-readable medium storing instructions that, when executed by the processor, cause the first device to perform the method, the method comprising:
receiving, from a second device, device identification information unique to the second device;
sending, to a trusted service, the device identification information received from the second device;
receiving, from the trusted service, contact information relating to a user associated with the second device identified based on the device identification information; and
updating a contact database associated with a user of the first device based in part on the contact information received from the trusted service.

2. The method of claim 1, wherein the method further comprises:
performing a polling process to identify devices within a range of a wireless communication channel of the first device,
wherein the device identification information is received from the second device in response to the polling process.

3. The method of claim 1, wherein the device identification information comprises at least one of a media access control address of the second device, a hash of a media access control address of the second device, and a key securely associated with the second device.

4. The method of claim 1, wherein the method further comprises:
displaying to the user of the first device, in response to receiving the contact information, an interactive prompt inquiring whether the user would like to add the contact information to the contact database; and
receiving a response to the interactive prompt from the user of the first device,
wherein updating the contact database is performed in response to receiving the response to the interactive prompt.

5. The method of claim 1, wherein the contact database comprises a database managed locally by the first device.

6. The method of claim 1, wherein the contact database comprises a database managed by the trusted service.

7. The method of claim 1, wherein trusted service comprises a social media service.

8. The method of claim 7, wherein updating the contact database comprises generating a social connection between the user of the first device and the user associated with the second device in the social media service.

9. The method of claim 1, wherein the method further comprises:
generating, by the first device, electronic content; and
associating the generated electronic content with the device identification information.

10. The method of claim 9, wherein associating the generated electronic content with the device identification information comprises including the device identification information in metadata associated with the generated electronic content.

11. The method of claim 1, wherein the method further comprises:
determining that the second device is proximately-located to the first device; and
displaying to the user of the first device, in response to determining that the second device is proximately-located to the first device, an interactive prompt inquiring whether the user would like to receive the device identification information from the second device;
receiving a response to the interactive prompt from the user of the first device; and
transmitting an indication of the response to the second device,
wherein receiving the device identification information is performed in response to the indication of the response transmitted to the second device.

12. The method of claim 11, wherein determining that the second device is proximately-located to the first device comprises identifying that the second device is within a range of a wireless communication channel of the first device.

13. The method of claim 12, wherein the method further comprises transmitting, to the second device, device identification information unique to the first device.

14. The method of claim 1, wherein the contact information comprises at least one of a name, a phone number, an e-mail address, a photo, an occupation, and a role of the user associated with the second device.
